(19) United States
(12) Patent Application Publication
(10) Pub. No.: US 2015/0130191 A1
(43) Pub. Date: May 14, 2015

(54) GRAVITY-BASED ENERGY-STORAGE SYSTEM AND METHOD

(71) Applicants: Robert C. Houvener, Hollis, NH (US); Clifford A. Goudey, Newburyport, MA (US); Tyler N. Doyle, Marblehead, MA (US)

(72) Inventors: Robert C. Houvener, Hollis, NH (US); Clifford A. Goudey, Newburyport, MA (US); Tyler N. Doyle, Marblehead, MA (US)

(73) Assignee: SeaPower Systems, LLC., Nashua, NH (US)

(21) Appl. No.: 14/395,248

(22) PCT Filed: May 3, 2012
(86) PCT No.: PCT/US12/36301

§ 371 Date: Nov. 14, 2014

Related U.S. Application Data
(60) Provisional application No. 61/482,337, filed on May 4, 2011.

(51) Int. Cl. H02K 7/18; F03B 13/14; F03B 13/26; F03D 9/00; F03B 13/10

(52) U.S. Cl. CPC H02K 7/1853; F03D 9/002; F03B 13/10; F03B 13/264; F03B 13/14
USPC 290/1 A; 290/55; 290/54; 290/53

(57) ABSTRACT

A system for harvesting, storing, and generating energy includes a subsurface structure supporting machinery to convert received energy into potential energy, store that potential energy, and at a later time convert that potential energy into electrical energy. The system includes one or more buoyant chambers that support the subsurface structure and are maintained with an internal that is approximately equal to the ambient pressure at their deployed depth. The system is anchored to the seafloor with one or more mo lines. Suspended from the subsurface structure are one or more weights that are hoisted up or lowered down by one or more winches The one or more winches comprise a spooling drum, and one or more motors and/or one or more generators or one or more motor/generators.

### TECHNICAL FIELD

The present invention relates to energy storage and more particularly, relates to a device that allows the efficient and low-cost storage and release of energy such as for use in electricity generating devices and electrical grids.

### BACKGROUND INFORMATION

Energy storage takes on many forms. Fossil fuels are the most ubiquitous and well known energy storage mechanism, having been formed of plant matter over millions of years and thereby storing solar energy. The key limitations of fossil fuels are that they take millions of years to store that energy and when you release it, such as through combustion, they emit massive amounts of greenhouse gases, which are harmful to the planet and human health. Other forms of energy storage include chemical storage such as in batteries, direct electrical storage such as in capacitors, kinetic energy storage such as in flywheels, mechanical storage such as in springs or compressed-gas energy storage, and lifted-mass storage such as pumped hydro.

As well documented in the DOE—ARPA-E: DE-FOA-0000290 (GRIDS) solicitation from the US Department of Energy in 2010, all of these energy storage methods suffer from one or more of the following limitations: 1) the capital cost is too high to be economically viable; 2) the siting of the devices is too restrictive and/or narrow to be of commercial value; 3) the efficiency of the charge/discharge cycles are too inefficient to be of commercial value; 4) the amount of storage (kilowatt hours) per installation is not scalable for utility-scale deployment; 5) the estimated number of charge/discharge cycles or lifetime of the method is too short to support utility-scale infrastructure lifetimes; and/or 6) the length of time the energy could be stored is limited and degrades too severely over time (such as flywheels which lose up to several percent of their energy per hour due to friction and other issues).

The US DOE ARPA-E noted that the current benchmarks for large scale energy storage for electrical grids were pumped hydro at $1,500 per kilowatt for capital cost and under $100 per kilowatt hour for storage, with other sources noting round-trip efficiency for pumped hydro of approximately 75%. They also noted that very few additional pumped-hydro plants could be built in the US due to their severe environmental impact and the limited number of locations that can support pumped hydro. However, they noted that in 2009 over 99% of electrical grid energy storage worldwide was in the form of pumped hydro. Utility experts involved with the construction of recent utility power plants state that a pumped-hydro plant such as the Northfield, Mass. 1GW plant would cost around $4,000/kW or $500/kWh to construct today, if it could be permitted, which they severely doubt. Similarly, ARPA-E noted that compressed-air storage at $600 per kW for capital cost and under $100 per kWh for storage, with other sources stating a round trip efficiency of 75-80%, was limited by the storage caverns or similar air storage mechanisms available, thereby making it a very limited option. After decades of compressed-air storage R&D, it has not moved beyond the research and pilot-project stage.

In the 2010 ARPA-E GRIDS FOA, reiterated in the ARPA E 2012 storage SBIR FOA, DOE set a high bar for advancing the state of the utility-scale energy storage marketplace. The goal was for proposers to develop technologies that would: 1) enable deployment near load centers; 2) be able to develop full power within 10 minutes; 3) provide rated power for at least 60 minutes; 4) have a round trip charge/discharge efficiency of greater than 80%; 5) be scalable to GW and GWhs of power and energy capacity; 6) have a capital cost of energy of less than $100/kWh; and 7) have at least 5,000 charge/discharge cycles before any storage capacity degradation.

ARPA-E states that: “electric storage with a 5000-cycle lifetime, round trip efficiency of 80% and $100/kWh storage cost, the premium storage cost per storage cycle would be $0.025/kWh above the electricity cost, which is within the predicted cost range for technology adoption relative to the cost of alternative approaches to regulation power”.

One of the main drivers for utility-scale energy storage is the fact that electricity has a very finite life. Once electricity is produced and transmitted, it must be used, or it will be lost. Equally important, if the amount of electricity being generated is not kept in close sync with the amount of electricity being consumed on the electrical grid, the frequency of the Alternating Current (AC) waveform on the transmission lines will go out of spec and equipment damage and large fines can quickly result. Since consumers of electricity expect electricity to be there when they need it, utility companies must have significant reserve capacity available and in some cases running, so that it can be supplied in the seconds and minutes response times that are needed to maintain grid stability.

By contrast, most new renewable energy sources are intermittent in nature. In the case of wind farms, when the wind slows or picks up, the output of the wind farm changes quickly and drastically. The same is true for solar, as clouds come over, output changes drastically and quickly. This combination of intermittent generating sources and intermittent consumption causes the grid to be highly inefficient. Essentially, power generators such as wind and solar can be told to shut down if there is too much power on the grid.

Alternatively, utility companies must keep large amounts of fossil fuel capacity running in the background so it can be quickly added to the grid as needed. This increases fossil fuel use and greenhouse gases and reduces the viability and effectiveness of intermittent clean-energy sources. This tremendous problem is what the US and global governments and industry are trying to tackle with advances in grid-scale energy storage R&D efforts. So far, according to ARPA-E and the US DOE, there has been limited success in meeting the goals. Accordingly, a device and method for usage is needed which enables the deployment of energy-storage systems that meet the needs of energy-generation devices, particularly intermittent ones, and grid operators to store energy, at both device and grid scale.

Although the concept of a hanging weight to store energy has been around of hundreds of years, such as is exhibited in clocks that use hanging weights to store the energy needed to run the clock for long periods of time. At a larger scale, in 1901 we see U.S. Pat. No. 680,038 by Gore 1901 that employed lifting weights to store the renewable energy of a windmill for later use in pumping water.

More recently, refined concepts have been introduced aimed at storing electrical energy from renewable sources in the potential energy associated with raising weights. In 2011, Scott was granted U.S. Pat. No. 7,973,420 where weights are hoisted inside vertical cylinders or through elaborate means of lifting and supporting weights in a storage structure.

In 2011, Boone received U.S. Pat. No. 7,944,075 for a vertical axis wind turbine that drives a potential energy storage system involving heavy weight or rail cars on inclined tracks. In the same year, Simnacker was granted U.S. Pat. No. 7,956,485 for a means of storing energy from a wind turbine by raising a fluid to an elevated tank.

It is important to note that each of the foregoing examples of prior art do not involve the use of the ocean's depths to provide the hoist (lift) height that is needed for large-scale and economical potential-energy-based storage.

More relevant to the current invention is a 2010 patent application by Morgan (US2010/0107627) where the concept of submerging a buoyant volume under water is introduced. This being the reverse process of lifting a weight, it nonetheless captures the value of the height offered by a body of water in potential-energy-based storage.

Equally relevant is another 2010 patent application by Ivy (US2010/0307147) where a fluid is pumped underwater and/or under backfill that provided the resistive force to maintain pressure in the fluid, thereby storing it as potential energy.

A 2009 application by Fiske (US2009/0193808) combines the idea of a suspended weight being raised and lowering them over the depth of the ocean to provide energy storage in the form of potential energy. Fiske also suggests combining this storage means with a wind turbine.

However, in all proposed forms there is a floating portion that is at the surface and therefore subject to the waves and other hazards on or near the surface. Fiske also specifies the suspended weight to be constructed of a dense material such as concrete, reinforced concrete or steel.

A 2010 application by Howson (US2010/0283244) describes a system similar to Morgan mentioned above where buoyant volumes are pulled to greater depth underwater in order to store potential energy, the power to do so being provided by an offshore, bottom-mounted wind turbine.

The present invention provides significant advantages over the prior art described above. None of them include the concept of submerged buoyancy provided by low-cost containment that is enabled by having the internal pressure match the ambient external pressure at the deployed depth. This design attribute contributes to an unprecedented low cost of energy storage that is needed to meet the market demands.

In addition, the present invention provides significant advantages over the prior art described above by introducing the concept of extremely low-cost mass enabled by the use of flexible fabric structures filled with dredged materials such as sand or gravel. This mass remains constant, regardless of the depth to which it is submerged. By contrast, inverted systems that use a buoyant volume will experience either a decrease in volume with depth or, if designed to be rigid, an increase in external pressure with depth. In either case the cost effectiveness of such a system will be impaired.

A further advantage of the present invention over the prior art is full submergence. The present invention has nothing at the surface that could couple the energy-storage system to the potentially destructive excitations of surface waves.

Specifically, application US 2010/0107627 by Morgan proposes a barge with a motor/generator, attached via cable to a pulley on the seafloor and via the pulley, to a buoyant body, attached to the end of the cable. The system suffers from a number of potentially fatal flaws, including 1) the cost, size, ruggedness and movement of the surface barge, which counteracts the buoyancy of the buoyant body at the far end of the cable, essentially doubling the amount of buoyancy needed in the system; 2) the need for a very large anchoring mechanism which will counteract twice the actual buoyancy of the buoyant body and movements of both the buoyant body and the barge; 3) the fact that the buoyant body at the far end of the cable will need to be crush resistant (and expensive) or it will collapse as it is pulled deeper into the water, reducing its buoyancy as it descends and increasing it as it ascends, dramatically altering the rate at which energy can be stored over a given depth; 4) the need to provide a tether between the buoyant body and the barge which has a length twice the depth of the body of water that the system is deployed in.

Neither Fiske nor Morgan describes a system with the ability to address the current needs for cost-effective energy storage at the system or grid scale. As with other mass-based energy-storage concepts, the cost of the structure needed to obtain height over which the mass can travel and the cost of the mass itself are cost drivers that will determine commercial viability. The present invention innovatively and uniquely addresses both of these drivers by: 1) introducing novel and innovative low-cost buoyancy, 2) exploiting deep water to obtain low-cost height and 3) utilizing low-cost mass via cost-effective containers for the mass combined with a novel and innovative manner to acquire, collect and load mass by the millions of pounds, at practically no cost, into the containers. These three attributes of the present invention i.e. relatively inexpensive buoyancy, height, and mass, enables a significant breakthrough in the commercial viability of large-scale energy storage.

The present invention enables the adoption of intermittent renewable energy sources that are highly problematic for utilities. As a result of this problem, the power from these renewable sources is currently less valuable to the utility companies. By incorporating energy storage through the adoption of the present invention, intermittent sources such as wind power, solar power, tidal power, and wave power can provide very-high-value peaking power to the grid. This ability to store renewable power (or excess power from other generating sources) at times of low electrical power prices and sell it to the grid at peak rates (often 3-5 times the rate paid by utilities for intermittent power) completely changes the market dynamics for renewable energy. Using the present invention, project developers can get significantly more revenue for each megawatt hour their project produces, while the utility company does not have to have standby fossil-fuel plants running to smooth out the amount of power on the grid.

Accordingly, an object of this invention is to provide a device and method of energy storage that is applicable where capital cost, ubiquitous deployment, efficiency of storage/release of energy, and energy storage/release cycle times are major factors in economic viability.

A further object of this invention is the integration of several innovative solutions to the drawbacks of competing energy-storage systems, thereby allowing a reduced-cost device to be easily deployed, quickly placed in service, and readily maintained over its lifetime, at sizes ranging from tens of kilowatt-hour individual systems to multi-unit gigawatt-hour utility-scale farms.

A still further object of this invention is to enable a new class of low-cost energy storage, uniquely characterized by novel low-cost buoyancy and mass, taking advantage of the ubiquitous hoist heights available at ocean depths convenient to load centers and locations suitable for ocean-based renewable energy device deployment.

A still further object of this invention is to enable the economic viability of intermittent sources of renewable energy generation, such as solar, wave, tidal and wind, both at the device and the grid level.

A still further object of this invention is to provide a stable subsurface platform for mounting various ocean-based renewable energy generation devices, thereby reducing their deployment costs and providing co-sited energy storage to increase the utility and therefore the value of the energy produced.

A still further object of this invention is to provide an energy-storage capacity in the deep ocean that can enable the economic exploitation of the US Exclusive Economic Zone by various ocean-based industrial and marine agronomy activities that would benefit from a consistent source of power.

### SUMMARY

The present invention combines a novel and disruptively low-cost buoyancy system and a novel and disruptively low-cost weight mechanism, with enabling motor/generator technology and enabling software, to provide a highly scalable and cost-effective energy-storage system for use in water-based deployment locations. This invention directly addresses the needs outlined by government agencies and industry groups alike for cost-effective energy storage. The invention stores energy by powering a motor that drives a large-capacity winch drum that pulls in a cable and thereby lifts a weight resulting in electrical-energy input being converted into potential (stored) energy. The invention releases this stored potential energy by allowing the weight to lower, thereby turning the winch drum and driving a generator, which produces electrical power.

The weight may be in the form of fabric containers filled with sand, rocks and other material dredged from the ocean or other water body floor at or near the deployment location of the system. The weight may alternatively be in the form of rigid or semi-rigid containers preferably filled with weighted material at or near the deployment site of the system. In this manner, no additional cost and difficulties are encountered in obtaining weight material and transporting the weighted material and/or containers to the deployment site. The weight material may also include material conveniently gathered not from the ocean or water—but rather from say a gravel pit nearby the launch location.

The buoyancy component of the invention includes relatively lightweight buoyancy units made from fiber-reinforced plastic (FRP) laminates. These buoyancy units are large, having 100 s to 1,000 s of cubic meters in volume and are operated in a way that maintains the internal pressure at or close to the ambient pressure at the depth under the ocean they are positioned. This results in a large economy of materials and low-cost compared to more conventional submerged buoyant structures that are operated as pressure vessels and must withstand the stress resulting from a significant pressure difference between their interior and exterior.

The mass component of the invention includes low-cost non-structurally-rigid containers that are filled with locally abundant ballast material that can be obtained at little or no cost. In one preferred embodiment, this mass is dredged material obtained from a suitable underwater location along the route between the system launch site and the ultimate deep-water deployment location or at/near the deployment location itself, preferably in shallow water although this is not a limitation of the invention. In this embodiment the mined sand or gravel comes at a cost that is trivially low and generally readily and accessible compared to other sources and methods of obtaining the hundreds of millions of pounds needed for cost-effective gravity-based energy storage. In still other embodiments, the mass is obtained within economically viable towing distances of the deployment site of the system. The low-cost containers, in one preferred embodiment, would be made of non-rigid synthetic material that is specially designed for use in subsea environments such as woven polyester fabric of high tensile strength.

Similar synthetic materials are utilized worldwide in the manufacture of marine ropes, commercial fish netting, geotextiles, and other applications where strength and durability are important. This material can be woven to make a high-strength fabric that can be assembled into three-dimensional cylindrical containers with rounded bottoms that make efficient use of the material while providing high-volume capacities. Suitably reinforced with webbing straps that lead to attachment means, these assemblages offer unique abilities for providing the many hundreds of tons of mass needed for utility-scale energy storage. These woven materials need not be watertight, requiring a coated fabric. Indeed in one preferred embodiment the porosity of the woven fabric is such that seawater and fines are allowed to pass through the containment wall thereby increasing the total density of the contained volume.

It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 represents a prior-art stabilized-platform design;

FIG. 2 represents a subsurface low-cost suspended-mass energy-storage system with the motor/generator/winch positioned on a buoyancy platform;

FIG. 3 represents a subsurface low-cost suspended-mass energy-storage system with the motor/generator/winch positioned on the suspended mass;

FIG. 4 represents a subsurface low-cost suspended-mass energy-storage system with a single-point mooring that acts as a suspended-mass guide;

FIG. 5 represents a subsurface low-cost suspended-mass energy-storage system with a wind turbine hosted on the buoyancy platform;

FIG. 6 represents a subsurface low-cost suspended-mass energy-storage system with a water current turbine hosted on a buoyancy platform;

FIG. 7 represents a side view of a subsurface low-cost suspended-mass energy-storage system with a water current turbine with a counterbalance hosted on a buoyancy platform;

FIG. 8 represents a subsurface low-cost suspended-mass energy-storage system with wave-energy converters hosted on a buoyancy platform;

FIG. 9 represents a networked redundant-membrane buoyancy system;

FIG. 10 represents an embodiment utilizing multiple roto-molded plastic tanks;

FIG. 11 represents an embodiment utilizing multiple fiber-reinforced plastic (FRP) tanks;

FIG. 12 represents the way modular buoyant chambers are mounted to frames;

FIG. 13 represents a method for adding mass to a subsurface low-cost suspended-mass energy-storage system; and

FIG. 14 represents a deployed kinetic-energy conversion system with structure, mooring, support vessel and ROV.

### DETAILED DESCRIPTION OF THE PREFERRED EMBODIMENTS

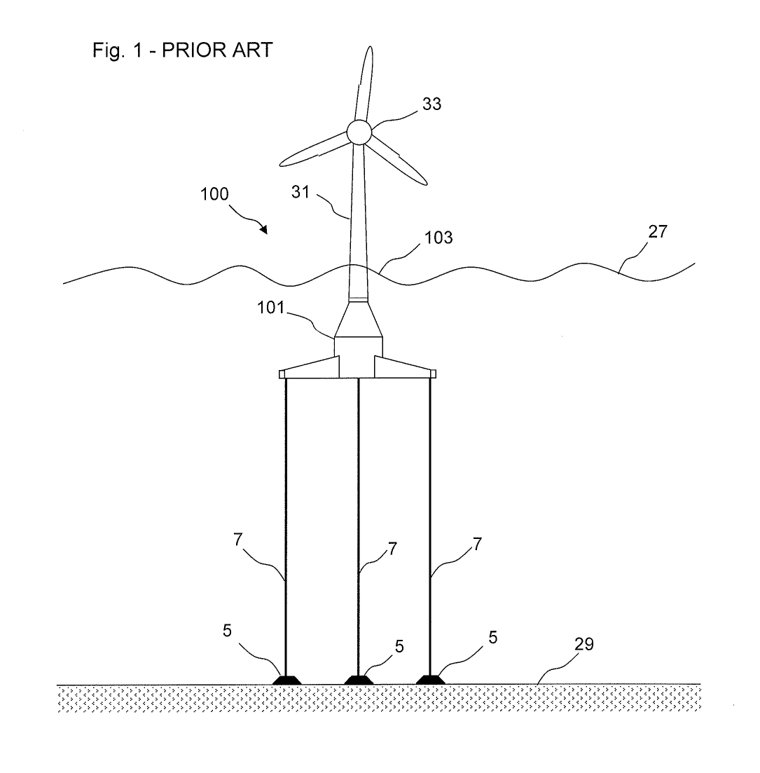

Referring to FIG. 1, there is shown a legacy or prior-art stabilized platform 100 that uses steel or other rigid material to form a submerged buoyant volume 101. In the example shown, the stabilized platform 100 supports a wind turbine 33 that is mounted on a tower 31 that penetrates the sea surface 27. Buoyant volume 101 is held submerged by mooring tendons 7 that lead to seafloor anchors 5. Buoyant volume 101 operates as pressure vessels and must be designed and built to withstand the external pressure associated with its depth below the surface as well as the rigors of operating at or near the surface due to passing waves 103. Large buoyant steel structures such as what is portrayed can cost $2 to $4 per pound of displacement plus the costs of proper corrosion-preventive coatings.

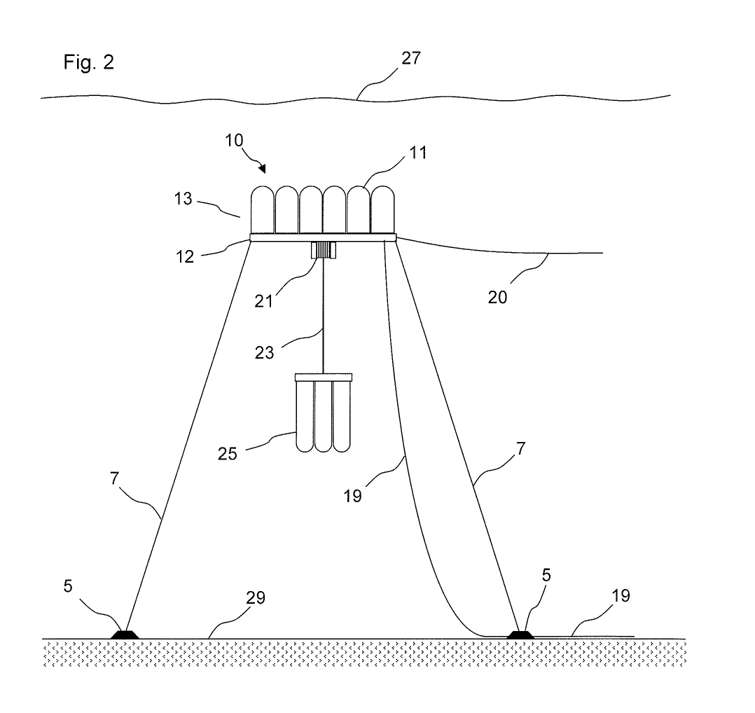

Referring now to FIG. 2, one embodiment of the subsurface low-cost suspended-mass energy-storage system 10 of the present invention is shown. The invention includes a buoyancy component or platform 13. In this embodiment, each of the multiple modular buoyant chambers 11 that make up the buoyancy component 13 are made of synthetic membrane, roto-molded plastic, or glass-reinforced plastic. The chambers 11 can be filled or vented of air in order to add and remove buoyancy from the system. Each chamber 11 is attached to a frame 12, which together forms the main structural members of the buoyancy platform 13 that is positioned below the sea surface 27 to avoid waves and maritime activity.

In this embodiment the motor/generator/winch 21 is mounted on the buoyancy platform 13, a position that would allow easy maintenance when the buoyancy platform 13 is surfaced. In this configuration, the power cable 19 leads from buoyancy platform 13 to the seafloor 29 where it can lead to shore. Alternatively, power cable 20 could lead from buoyancy platform 13 in a generally horizontal direction to a neighboring energy-storage system or a renewable-energy device.

The platform structure 13 is moored to the seafloor 29 via mooring lines 7 and anchors 5, thereby maintaining its position. This mooring mechanism, and those depicted in subsequent figures, can be of various configurations known in the art, such as Tension Leg Platform (TLP), catenary, weighted catenary, single point mooring and others. Two mooring lines 7 are shown, however, there may be more spaced equally around the platform structure 13 or in specific directions depending on the prevailing oceanic conditions.

Umbilical cable 19 that connects to the motor/generator/winch 21 and various other power and control components facilitates the transfer of power to the grid or other demand load and serves as a communication link between an off-platform or shore-based control center that operates the system in optimal fashion.

Hanging below the buoyancy platform 13 we see multiple mass modules 25 that are together supported by a tension member 23 to the motor/generator/winch 21 and the buoyancy platform 13. When the mass modules 25 are being raised, energy is consumed by the system via the motor element of motor/generator/winch 21 and when the mass is being lowered, energy is generated via the generator element of motor/generator/winch 21. The motor and the generator elements can be the same device, just run in different modes or they can be separate devices.

In addition to the conversion of the potential energy stored in the lifted masses 25 to electricity and the transmission of the energy via the electrical cable 19, other methods can be utilized to act as the carrier for the stored energy.

In one embodiment, the stored energy can be turned back into electricity via the generator and that electricity can be utilized to generate a liquid or gaseous energy carrier such as via electrolysis of water to create hydrogen and oxygen, or conversion to products, which have high-energy storage density such as anhydrous ammonia. This conversion to non-electrical energy carriers is especially useful in areas of great depths but limited access to those in need of electricity. Since it is not economically practical to run a high capacity (Gigawatts) subsea cable over very long distances (many hundreds to thousands of miles), the non-electrical energy carrier enables the locally collected energy to be converted to a suitable carrier fuel. This fuel can be loaded onto a transport ship, utilized on-board, as well as transported in bulk on ships to locations globally where the energy can be utilized via the energy carrier (such as the anhydrous ammonia or others).

This embodiment of the present invention allows the system to be deployed in these remote areas, where it stores energy generated over long periods of time via a kinetic-energy-conversion device(s) such as the wave-energy system described herein, with ships or other transport mechanisms being used to distribute the energy in a cost effective manner to global users of energy. In this manner, very limited bulk storage of the liquid or gas is needed on the platform, as the conversion from potential energy to electricity to gas or liquid can be done at the time the transport is ready to receive it.

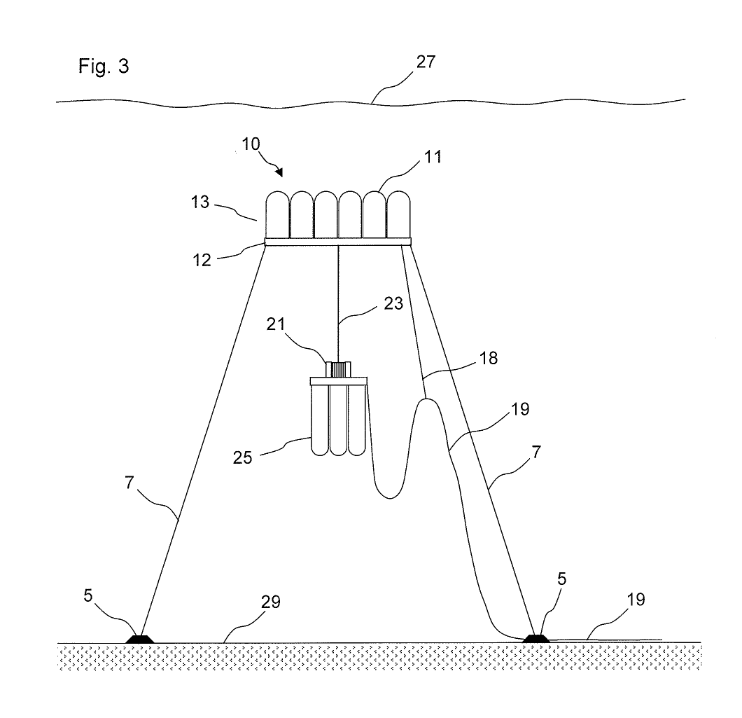

Referring now to FIG. 3, there is shown one embodiment of the subsurface low-cost suspended-mass energy-storage system 10 with multiple modular buoyant chambers 11 attached to a frame 12, which together forms the main structural members of the buoyancy platform 13 that is positioned below the sea surface 27 to avoid waves and maritime activity.

In this embodiment, the motor/generator/winch 21 is not mounted on the buoyancy platform 13 and instead is mounted on the suspended mass 25. In this position, the mass of the motor/generator/winch 21 contributes to the overall mass of the suspended-mass energy-storage system 10. In this configuration, the power cable 19 leads from suspended mass 25 to the seafloor 29 where it can lead to shore. Power cable 19 is supported in an intermediate location between suspended mass 25 and seafloor 29 by support means 18, which provides both mechanical support and a means for power and control signals to reach the buoyancy platform 13. Alternatively, power cable 19 could lead to the buoyancy platform 13 and thence in a generally horizontal direction to a neighboring energy-storage system as was shown in FIG. 2.

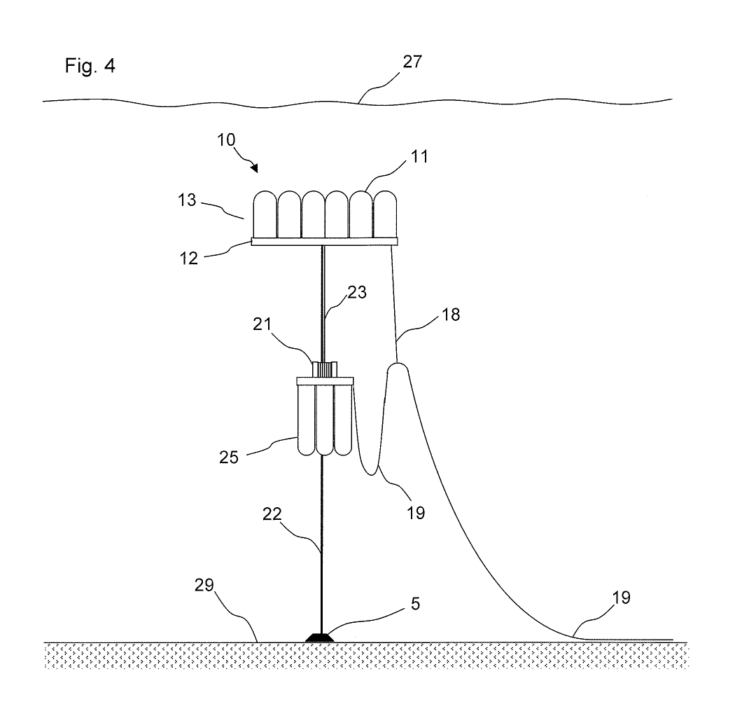

Referring now to FIG. 4 is an embodiment of the present invention which utilizes a single-point mooring system wherein the mooring line(s) 22 both anchor the buoyancy platform 13 to the seafloor 29 and serve as a guide for the suspended mass 25 as it is raised and lowered by motor/generator/winch 21 and tension member 23. In this figure the motor/generator/winch 21 is shown mounted on the suspended mass 25, contributing to the overall mass of the suspended-mass energy-storage system 10. In this configuration, the power cable 19 leads from suspended mass 25 to the seafloor 29 where is can lead to shore. Power cable 19 is supported in an intermediate location between suspended mass 25 and seafloor 29 by support means 18, which provides both mechanical support and a means for power and control signals to reach the buoyancy platform 13. Alternatively, power cable 19 could lead to the buoyancy platform 13 and thence in a generally horizontal direction to a neighboring energy-storage system as was shown in FIG. 2.

The motor/generator/winch 21 is guided along mooring line(s) 22 thereby preventing undesirable horizontal motions that could be induced by ocean currents. A single mooring line 22 is shown; however, two, three, four or more mooring lines 22 could be employed depending on the situation and the selection of materials. Multiple mooring lines 22 not only would prevent undesirable swinging of the suspended mass 25, but it would also prevent rotation.

The embodiment shown in FIG. 4 would work equally well if the motor/generator/winch 21 were mounted on the buoyancy platform 13 as exemplified in FIG. 2.

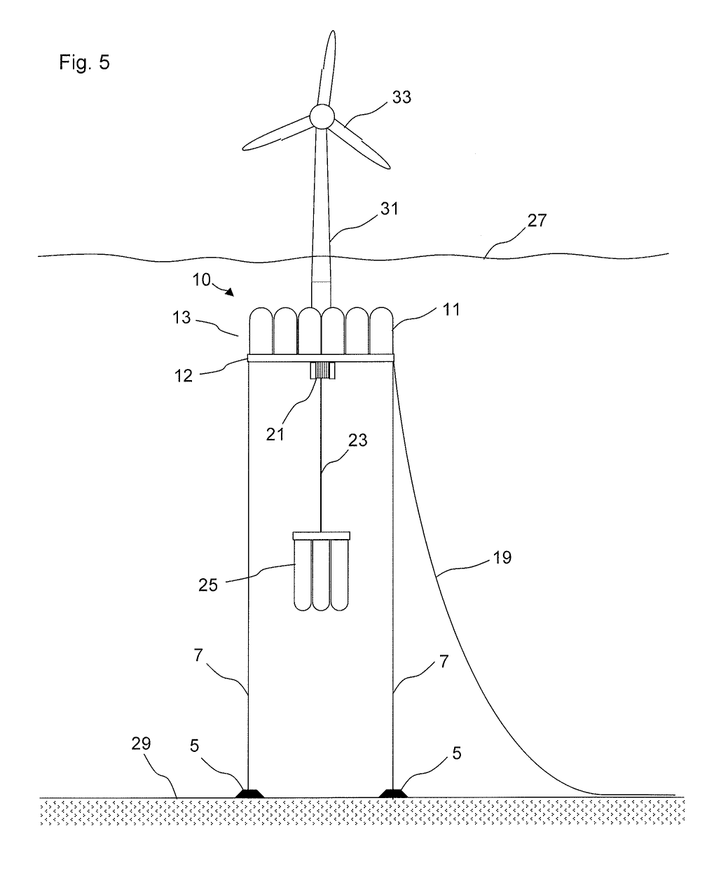

Referring now to FIG. 5 is shown an embodiment of the present invention in which the buoyancy platform 13 is host to a kinetic energy conversion device such as a wind turbine that is mounted vertically by means of a tower 31 that penetrates the sea surface 27 presenting the rotor 33 to the prevailing winds. In this case, the subsurface low-cost suspended-mass energy-storage system 10 can be directly utilized to store the intermittent energy produced by the wind turbine rotor 33.

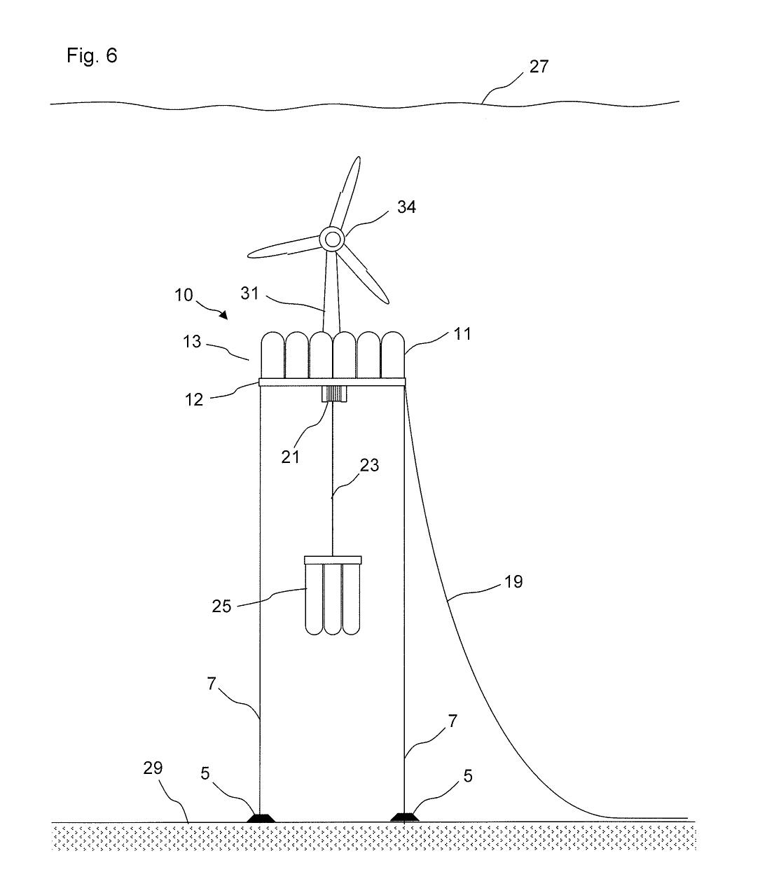

Referring now to FIG. 6 is illustrated an embodiment of the present invention in which the buoyancy platform 13 is host to a kinetic energy conversion device such as an underwater tidal or ocean current turbine that is mounted vertically by means of a tower 31 presenting the rotor 34 to the prevailing currents. As with the wind turbine shown in FIG. 5, the subsurface low-cost suspended-mass energy-storage system 10 can be directly utilized to store the intermittent energy produced by the hydrokinetic energy-conversion rotor 34. In addition, the subsurface low-cost suspended-mass energy-storage system 10 can be utilized to store more uniformly produced energy such as in ocean currents, in order to utilize that energy at times where that energy is of more value to the various players in the electricity value chain.

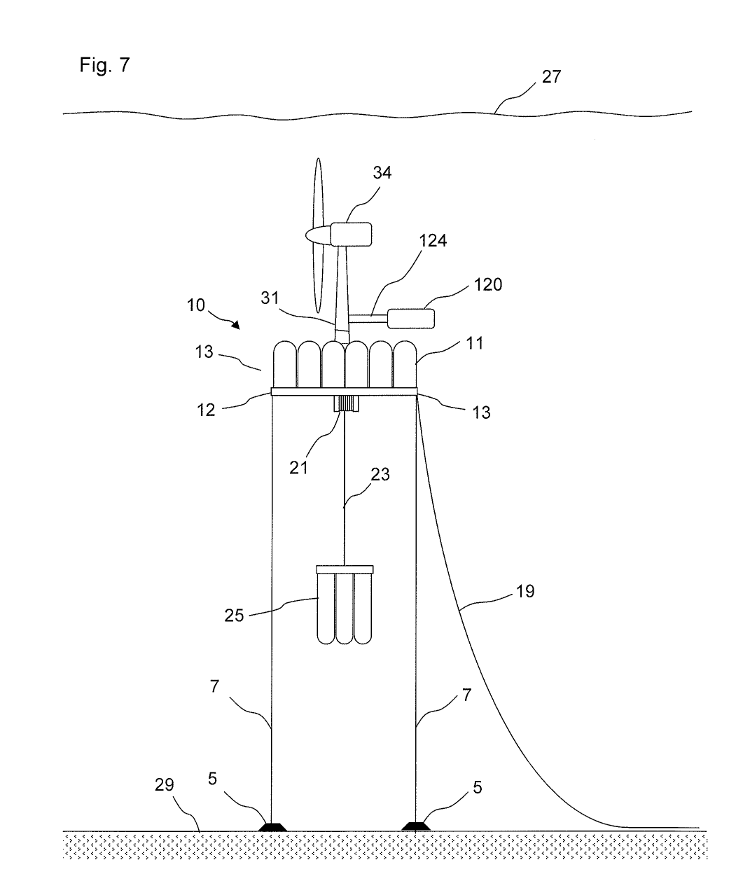

FIG. 7 is the same embodiment shown in FIG. 6 except that the rotor 34 has been rotated 90 degrees atop the tower 31 to reveal a counterbalancing arm 124 that supports a counterbalancing buoyancy module 120. This assembly helps both orient the tidal current turbine into the direction of flow and reduces the clockwise torque caused by the drag of rotor 34.

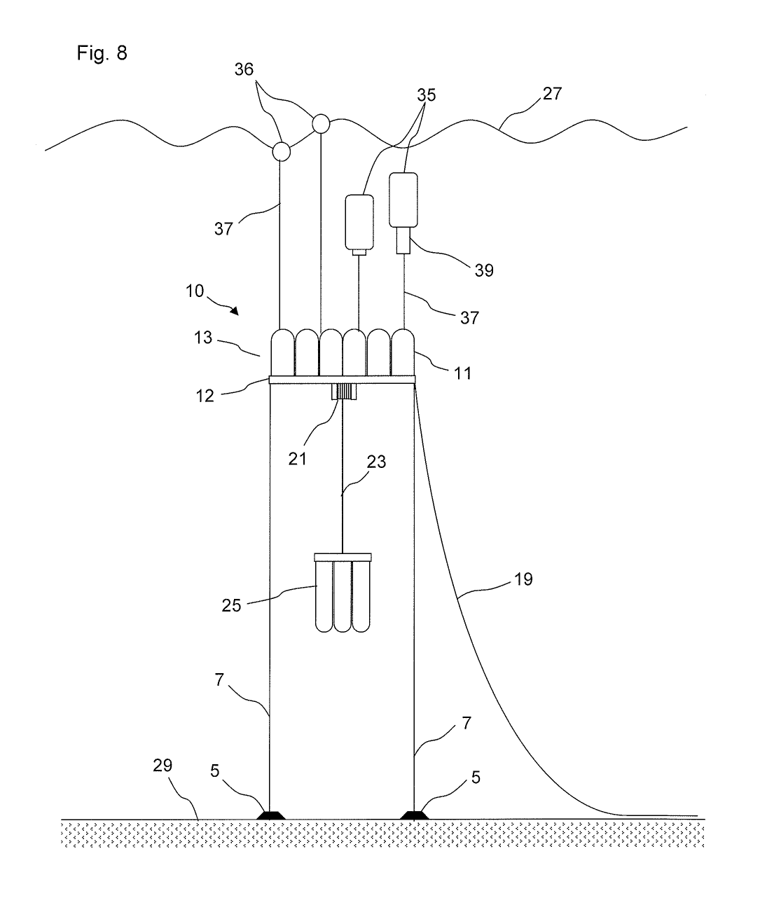

Referring now to FIG. 8 is an embodiment of the present invention in which the buoyancy platform 13 is host to a kinetic energy conversion device such as a wave-energy conversion mechanism. Two types of wave energy conversion mechanisms are portrayed in FIG. 8, both types connected to the buoyancy platform 13 by cables 37. Wave-energy conversion mechanism 36 is a simple floating buoy that heaves up and down depending on the height of the water surface. This up and down movement of the buoy 36 yields useful power at the buoyancy platform 13 that can be used to drive a generator or some other form of energy extraction system that can be cabled to shore via power cable 19 or stored using the suspended-mass energy-storage system.

Wave energy conversion mechanism 35 is a simple submerged chamber that changes volume due to the change in pressure under passing waves. The change in volume results in a vertical movement of the chamber 35 relative to the stationary portion 39 that can be used to drive a generator or some other form of energy extraction system. The basic wave energy conversion concept is very well documented art and commonly utilizes either at surface or near-surface buoyancy devices, with dozens of companies working with the basic concept, sometimes referred to in the art as point absorbers.

Examples of such legacy concepts are being developed by companies such as AquaEnergy Group, LTD (AquaBuOY) and Ocean Power Technologies (PowerBuoy), as documented in: Wave Energy Potential on the US Outer Continental Shelf, US DOI, MMS May 2006.

The use of the buoyancy platform 13 to create a false seafloor for attaching the conversion system 35 and 36 allows several advantages including a shorter length of cable 37, the ability to be economically located in deep offshore locations where there is greater wave energy compared to shallow water, and the ability to utilize the subsurface low-cost suspended-mass energy-storage system 10 to store the intermittent energy produced by the wave energy converters 35 and/or 36.

As with the embodiment shown in FIG. 4, the advantages for the energy storage system in a dual-use platform are also significant versus stand-alone energy-storage concepts, as there are a number of capital-intensive infrastructure pieces that the energy-storage system is sharing with the wave or wind or other energy-conversion system, which reduce the overall Cost of Electricity for the storage system in this dual-use platform case. Alternatively, the ability for co-hosting to reduce the number of key components needed to be supplied by the kinetic-energy conversion system by 40-70% can completely change the economics of the deployment of the kinetic-energy conversion system, making it economically attractive versus economically non-viable.

One particularly useful embodiment of the present invention, not shown, but similar to FIGS. 5 through 8, utilizes the kinetic energy conversion to generate electricity, stores that energy in the subsurface low-cost suspended-mass energy-storage system and utilizes that stored energy, as needed, to power electronic systems on-board the platform. This innovation has many practical applications, including the powering of sea-based remote Department of Defense systems, oil and gas platforms, deep-sea mining systems, marine fish farms, marine agronomy facilities, and stationary fish capture systems. Currently, such systems must rely on various combinations renewable and/or fossil fuel generation capabilities coupled with batteries to provide a continuous supply of power. As with grid-based storage and retrieval of electrical energy, on a standalone basis, the present invention is low cost, scalable and very compelling.

The relatively uneven power output from the generation mechanisms portrayed in FIG. 8 can be directly stored in subsurface low-cost suspended-mass energy-storage system providing, inter-wave, wave to wave, as well as long-term energy storage (minutes, hours and days) of the output of the wave energy conversion mechanisms 35 and 36.

In the embodiments shown in FIGS. 5 through 8, mechanisms other than electrical power can be used to transfer the extracted kinetic energy from the kinetic-energy-conversion device to the task of lifting the mass. These mechanisms include hydraulic and direct mechanical coupling.

The storage of short term (wave to wave and within each wave cycle) energy of the present invention in a novel, scalable, and low cost manner is a step-function breakthrough for the harnessing of what the US Government has estimated as thousands of Terawatt-hours (TWhs) of wave energy available globally each year. This is partially due to the fact that electrical systems do not tolerate highly varying and impulsive kinetic energy well, without some sort of smoothing or energy-storage mechanism to serve as a buffer or aggregator of the energy for delivery to the grid.

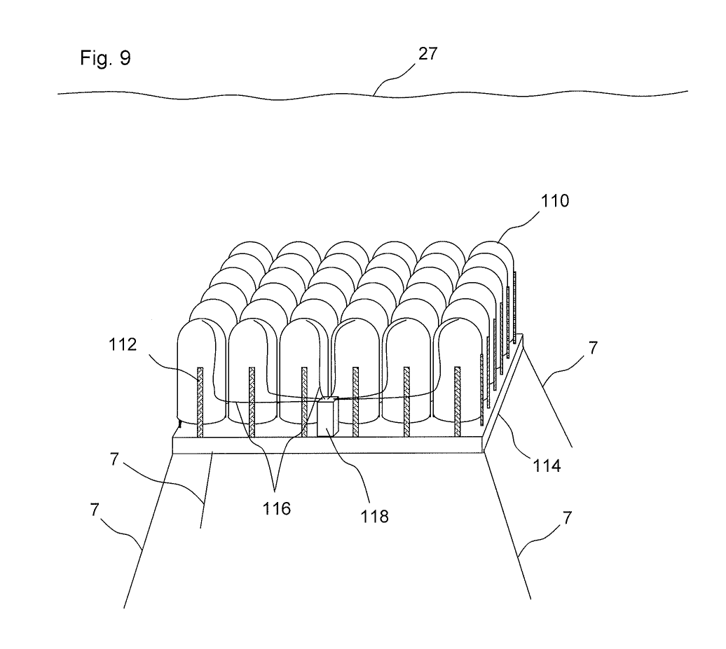

Referring now to FIG. 9 is shown a preferred embodiment of the present invention that utilizes an innovative and highly cost-effective buoyancy-control system. In this embodiment multiple flexible watertight containers 110 are arranged on structural framework 114. These flexible watertight containers 110 are similar in construction to underwater salvage bags that are commonly used in marine salvage and construction, exemplified in products by Subsalve USA (http://www.subsalve.com/) or Carter Lift Bag, Inc. (http://carterbag.com/). These flexible watertight containers 110 are attached to structural framework 114 by reinforcement strap 112 around their lower perimeter. Each flexible watertight container 110 is networked to a gas distribution unit (GDU) 118 via hoses 116.

Unlike prior art buoyancy-control systems that are designed around steel or other rigid pressure vessels, the use of this upwardly suspended network of flexible watertight containers 110 provides a durable solution to providing low-cost buoyancy. The gas distribution unit 118 can be fed gas from on-board cylinders, an attached compressor, or a remote supply line (all three not shown). A fully redundant gas distribution and monitoring system, with dual lines, controllers, attachment points on the bladders and communications and sensor mechanisms is utilized in the preferred embodiment of the buoyancy-control system. To avoid the need for emergency repair and potential platform loss, should one flexible watertight container 110 fail, redundant unused units would be inflated to retain the needed overall buoyancy.

By filling a specific flexible watertight container 110 with gas, it is inflated, resulting in increased buoyancy. By controlling which flexible watertight containers 110 are inflated, via the computer-controlled GDU 118, the attitude of the structural framework 114 can be maintained. In an alternate embodiment (not shown), the flexible watertight containers 110 could be fitted such that, once inflated, they would seat underneath the structural framework 114 held in place by their own buoyancy.

The embodiment shown in this figure has very favorable lift-per-dollar and lift-per-weight ratios, both of which are much higher than other conventional methods of supplying buoyancy, such as steel. For example, the SubSalve model PF70000, provides 77,000 lbs of lift, at a cost of $6,000 retail and weighs 410 lbs. This yields a lift-per-dollar ratio of 77,000/6,000=12.8 lbs per dollar, and a weight-per-pound-of-lift ratio of 77,000/410=188 pounds of lift per pound of weight. Importantly, in the present invention, multiple of these types of bladders are networked in order to provide as much buoyancy as needed, in the case of some versions of the present invention, 100's of tons or millions of pounds of lift. This compares very favorably with more conventional methods of providing buoyancy where the ratio is $2 to $4 per pound and the lift-per-weight ratio for steel that ranges from 8 to 15.

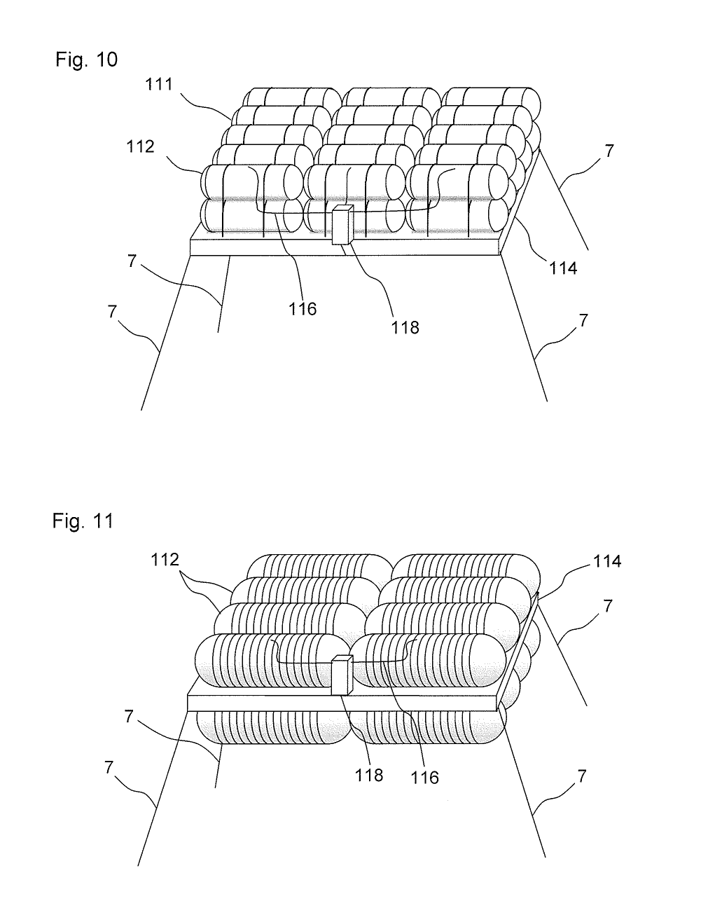

Referring now to FIG. 10 is a second preferred embodiment of the present invention that utilizes multiple roto-molded plastic tanks 111 to provide low-cost buoyant volumes. These tanks 111 are arranged on structural framework 114. These roto-molded plastic tanks 111 common in process and bulk storage industries and exemplified in products Peabody Engineering & Supply, Inc. (http://etanks.com/) and Chem-Tainer Industries (http://www.chemtainer.com). These roto-molded plastic tanks 111 offer some advantages over the flexible watertight containers 110 shown in FIG. 9 in that they offer some resistance to internal or external pressure, they provide the ability to be formed in advantageous shapes, and they offer excellent lift-per-dollar and lift-per-weight ratios. Each roto-molded plastic tank 111 is networked to a gas distribution unit (GDU) 118 via hoses 116. Valve-controlled vents at the bottom of each roto-molded plastic tank 111 allows their controlled flooding or emptying. By controlling which roto-molded plastic tanks 111 are flooded via the computer-controlled GDU 118, the attitude of the structural framework 114 can be maintained.

FIG. 11 illustrates a third preferred embodiment of the present invention that utilizes multiple fiber-reinforced plastic (FRP) tanks 112 arranged on structural framework 114 to provide low-cost buoyant volumes. These FRP tanks 112 are common in liquid storage applications and as underground storage tanks. They are exemplified in products made by Xerxes Corp. (http://www.xerxes.com/) and Containment Solutions, Inc. (http://www.containmentsolutions.com/).

Each FRP tank 112 is networked to a gas distribution unit (GDU) 118 via hoses 116. Valve-controlled vents at the bottom of each FRP tank 112 allows their controlled flooding or emptying. By controlling which FRP tanks 112 are flooded via the computer-controlled GDU 118, the attitude of the structural framework 114 can be maintained.

These FRP tanks 112 offer additional advantages over the roto-molded plastic tanks 111 shown in FIG. 10 and the flexible watertight containers 110 shown in FIG. 9 in that they offer significant resistance to internal and external pressure. This feature allows for a fixed buoyant volume that does not change in magnitude with changes in submerged depth, thereby requiring less active buoyancy control interventions by the gas distribution unit 118. These FRP tanks 112 also offer excellent lift-per-dollar and lift-per-weight ratios.

Referring now to FIG. 12 are modular buoyant chambers 11 mounted to frame(s) 12, which is part of the buoyancy platform 13. These modular buoyant chambers 11 are preferably mounted in a way that minimizes the overall frontal area that is exposed to the flow, thereby minimizing their fluid drag and improving the performance of the system when positioned in a current. Whether fabricated from synthetic membrane, roto-molded plastic or fiber-reinforced plastic, attachment to the frame(s) 12 is done in a way to prevent stress concentrations in the buoyant chambers 11.

Referring now to FIG. 13 is an embodiment where the mass or weight modules 25 are being filled with low-cost ballast such as sand, gravel, rock or other non-rigid material that is supplied from a surface vessel or barge 15 on the surface 27. This process is preferable undertaken after the subsurface low-cost suspended-mass energy-storage system 10 has been launched and is in transit to or actually at or near its deep-water deployment location. The sand or gravel is pumped down the pipe 17 as a slurry and into each mass module 25. In another preferred embodiment, a small offshore workboat 16, with an air compressor aboard, is positioned near the subsurface low-cost suspended-mass energy-storage system 10. Compressed air is sent down the hose 3 to the seafloor 29 were the air is released into a larger hose 18, which leads to one of the mass modules 25. As the air rises in the hose 18 it creates a rapid upward flow of the seawater it contains which sucks up seawater and sand or similar materials from the seafloor 29. At the other end of the hose 18 the sand is deposited into the mass module 25 until it is full, at which point the hose 18 is moved to another mass module 25 and the process is repeated. In this manner, each of the mass modules 25 is filled to capacity with hundreds of thousands of pounds of sand or similar material in an extremely low-cost manner. Not only is the material that serves as the mass low cost but there is no added cost in obtaining and transporting the mass or weight to the deployment site.

In another embodiment, a bulk material pump or similar mechanisms, including but not limited to those utilized in dredging systems, can be utilized in place of the compressed air pumping mechanism noted above. It should be noted that the process of filling mass modules 25 does not need to occur at the final system deployment location, but can happen in relatively shallow water and can be done at any location that is economically proximate to the deployment location.

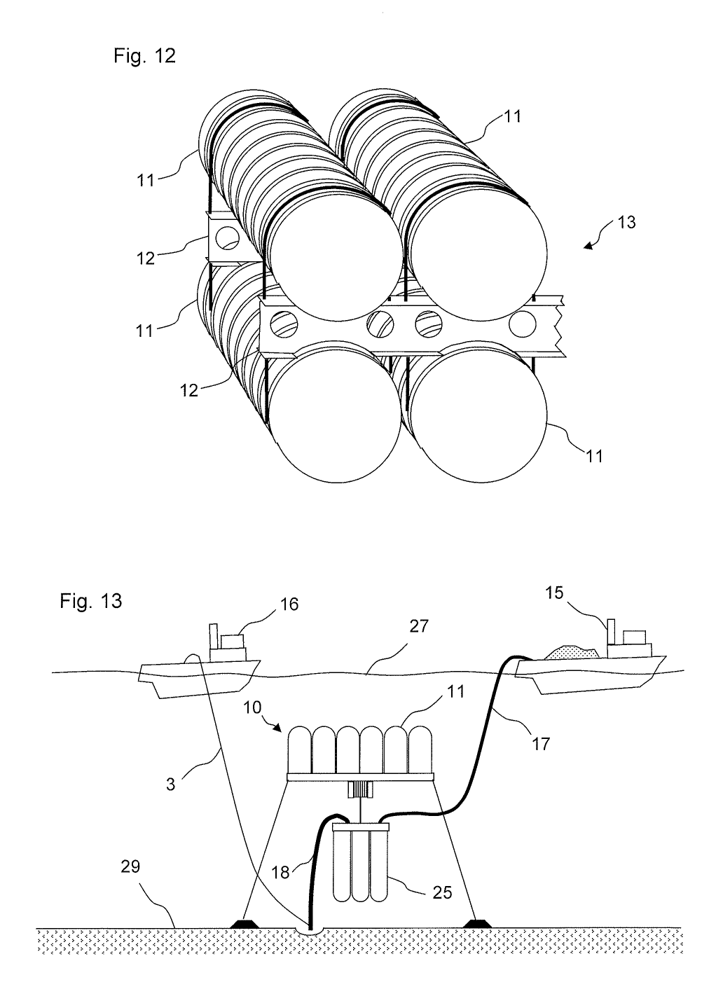

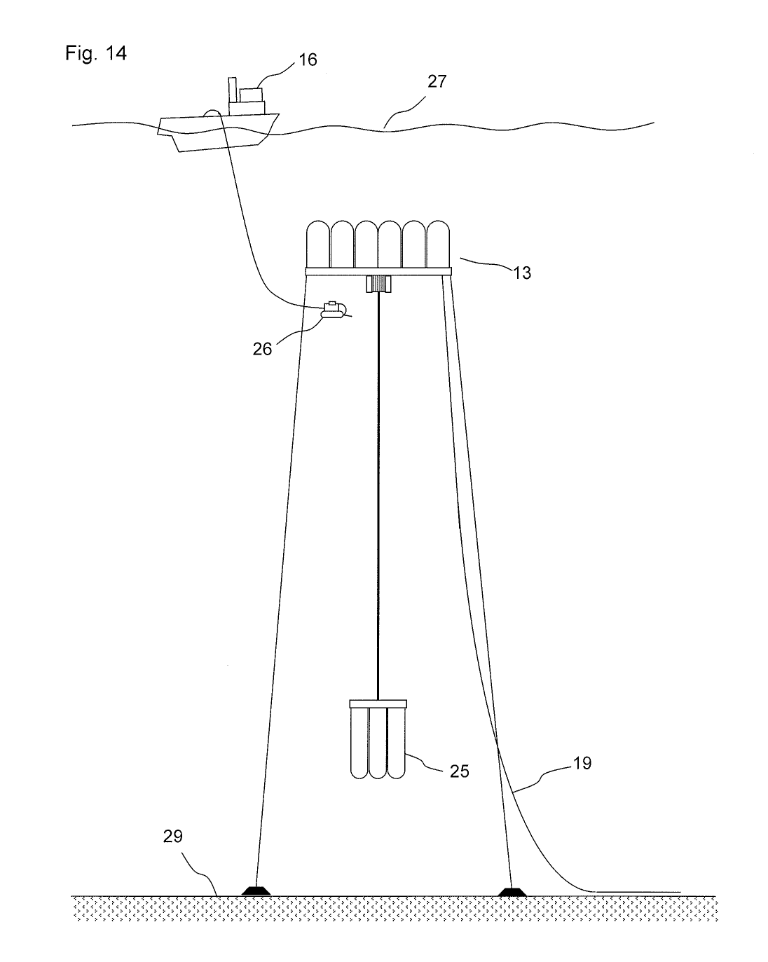

Referring now to FIG. 14 is shown a preferred embodiment of the present invention in a deployed location showing the buoyancy platform 13, the suspended mass 25, a support vessel 16, and a remotely operated vehicle (ROV) 26 engaged in system inspection or maintenance. Through the use of materials with a density less than or equal to that of water and the incorporation of buoyant volumes, many components of the present invention can be rendered neutrally buoyant to facilitate the removal and replacement of such components using ROV 26.

The present invention is similar to a modern elevator, enabling both long (hours) and short (seconds) term energy storage. The present invention provides cycle times between storage and retrieval of energy that are measured in seconds, scalability from kilowatt hours (kWhs) to megawatt hours (MWhs) per device and MWhs to tens of gigawatt hours (GWhs) per installation, all at a fraction of the cost of other device-level or utility-scale storage solutions. For example, a recent (April 2011) US DOE grant to Duke Energy, for an energy storage solution of 36 megawatts and purportedly 10 MWh will cost $44M or approximately $1,200 per kilowatt and $4,400 per kilowatt-hour.

Based on data from eXtreme Power, the supplier of the Duke battery based system, the system will rather quickly lose capacity over time, as the batteries are cycled, presenting a further significant cost and maintenance problems at utility-scale product lifetimes of 10-20 years. A recent 20 MW flywheel-based storage system in NY, also funded by a US DOE grant, cost approximately $65M or $3,250 per kilowatt, according to company officials. It is anticipated that the present invention will deliver device and grid-scale energy storage at a cost that is approximately one tenth of the cost of these most recent government and industry-funded utility-scale storage solutions. Unlike legacy energy-storage systems noted elsewhere in this application, the current invention can cost effectively (as specified in the US DOE ARPA e FOA noted elsewhere in this application) both store and release energy at the platform level.

Those with expertise in the areas of knowledge required for large offshore platforms will recognize the applicability of this novel innovation for other applications such as offshore wind, as well as other applications needing cost effective but highly stable marine platforms. A further embodiment of the present buoyancy platform of the present invention has a hydrokinetic turbine mounted below the buoyancy platform and a wind turbine mounted above the platform, with the tower of the wind turbine penetrating the water surface. In this dual-use embodiment, a particularly cost effective offshore renewable energy resource is created, which taps not only water currents, but also wind currents, in locations that happen to have both of these resources in the same geographic area. Of course this configuration could be further integrated with the primary aspect of the present invention, the energy storage means creating a triple-use embodiment and further cost savings.

The advantages of the invention described herein will be apparent to those of expertise in the fields of ocean platforms. Reports created by the US National Renewable Energy Laboratory, a division of the US Department of Energy, such as report NREL/CP-500-34874, released in 2003 and titled Feasibility of Floating Platform Systems for Wind Turbines, as well as NREL/CP-500-38776, released in 2007 and titled Engineering Challenges for Floating Offshore Wind Turbines, clearly highlight many of the long-standing technical and economic barriers which the present invention solves.

The ability to cost effectively store and release energy at the megawatt level, per platform, at low cost, over seconds to hours, for years on end, over many thousands of cycles, with a round trip efficiency of 90+ percent, that can be deployed in Gigawatt and Gigawatt-hour-size farms that are near most of the world's population centers, makes the present invention a game changer in the utility-scale energy-storage marketplace.

The advantages of the invention described herein will be apparent to those with expertise in related fields. The present invention solves numerous deficiencies in the prior art providing a novel and non-obvious way to enable a whole new class of water-deployed low-cost mass and low-cost buoyancy-based utility-scale energy-storage systems and multi-use platforms. The subsurface energy-storage system of the present invention is advantageously used to store various time frames of energy to meet the needs of one or more of the following; managing peak power demand, load balancing, or voltage management, and wherein this stored energy being used on timescales of seconds to hours. In addition, the subsurface buoyancy components and the suspended-weight components are preferably fabricated from materials such as fibers, fabrics, and resins that allow their manufacture and/or assembly at or close to the launch site, eliminating the logistical complexities and costs associated with the transport of large objects.

While the benefits of one element or another will quickly be obvious to an experienced energy or marine engineer, the particular innovation itself is not obvious due to the detailed multidisciplinary analysis needed in order to understand the limitations of prior-art energy-storage systems, their development, deployment and ongoing cost. The isolation of the full-life-cycle cost drivers and non-traditional highly multi-disciplinary design approaches led to the novel and unique innovation with the desired and unprecedented cost/benefit of the present invention.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A system for storing and releasing energy, wherein the system is deployed and fully submerged below the surface of a body of water and configured for storing and releasing energy, said system comprising:
a buoyancy component, said buoyancy component generally fully submerged below the surface of a body of water;
one or more suspended weights, coupled to said generally fully submerged buoyancy component;
at least one tension member, coupled to said one or more suspended weights and to said generally fully submerged buoyancy component, each said at least one tension member having a length, and configured for supporting the one or more suspended weights from said generally fully submerged buoyancy component;
a winch system, operatively coupled to said at least one tension member, and configured for adjusting the length of the at least one tension member in a controlled fashion, and operative in a first mode for receiving energy from an external source and for raising the one or more suspended weights thereby converting said energy received from an external source to stored potential energy, and operative in a second mode for releasing the raised one or more suspended weights thereby converting said stored potential energy into generated power.

2. The system of claim 1, wherein the subsurface buoyancy component is deployed in a body of water at a height below the surface of the body of water to a depth equal to or greater than the 100-year storm wave height at the deployed location.

3. The system of claim 1, wherein the subsurface buoyancy component comprises a plurality of chambers formed from one or more elements selected from the group consisting of high-strength flexible fabric; chambers roto-molded of plastic; and chambers fabricated from fiber-reinforced plastic.

4. The system of claim 3, wherein an internal pressure of the plurality of chambers of the subsurface buoyancy component are maintained using a gas to maintain the internal pressure to within 2 psi of the local ambient pressure of their deployment depth.

5. The system of claim 4, wherein the gas used to maintain said internal pressure is air.

6. The system of claim 1, wherein the suspended weight component comprises one or more containers formed from high-strength, flexible fabric filled with sand, gravel, rocks or other heavy, granular materials.

7. The system of claim 1, wherein the suspended weight component comprises one or more containers formed from high-strength, flexible fabric having a porosity that allows water to pass through but retains grain sizes over 60 microns and is filled with sand, gravel, rocks or other heavy, granular materials.

8. The system of claim 1, wherein the suspended weight component comprises one or more rigid or semi-rigid containers formed from materials including fiber reinforced plastic (FRP), and wherein said one or more rigid or semi-rigid containers are filled with sand, gravel, rocks or other heavy, granular materials.

9. The system of claim 1, wherein the tension member that supports the suspended weight component is made of high-strength, high modulus fibers that are sufficiently flexible to spool on a winch drum.

10. The system of claim 1, wherein the winch system includes a drum, a generator and a motor, and wherein said winch system is mounted on the subsurface buoyancy component.

11. The system of claim 1, wherein the winch system includes a drum, a generator and a motor, and wherein said winch system is mounted on the suspended weight.

12. The system of claim 1, wherein the stored and released energy is in the form of electrical energy.

12. The system of claim 1, wherein the released energy is in the form of hydraulic, mechanical, or electrical energy.

14. The system of claim 1, wherein the system is deployed proximate to one or more kinetic energy conversion devices, and wherein the one or more kinetic energy conversion devices are configured to release energy to be sent to an energy grid or stored on the system.

15. The system of claim 1, wherein the subsurface buoyancy components and the suspended weight components are fabricated from materials selected from the group consisting of fibers, fabrics, and resins, and configured for allowing their manufacture at or close to the launch site, eliminating the logistical complexities and costs associated with the transport of large objects.

16. The system of claim 1, wherein the subsurface buoyancy components are designed to be neutrally buoyant underwater.

17. The system of claim 1, wherein the subsurface buoyancy component comprises a plurality of chambers, and wherein the plurality of chambers are designed to be neutrally buoyant underwater.

18. The system of claim 10, wherein the motor and the generator are designed to be neutrally buoyant underwater.

19. A system for storing and releasing energy, wherein the system is located on a platform deployed and fully submerged below the surface of a body of water and configured for storing and releasing energy, said system comprising:
a buoyancy component, said buoyancy component generally fully submerged below the surface of a body of water;
one or more suspended weights, coupled to said generally fully submerged buoyancy component;
at least one tension member, coupled to said one or more suspended weights and to said generally fully submerged buoyancy component, each said at least one tension member having a length, and configured for supporting the one or more suspended weights from said generally fully submerged buoyancy component;
a winch system, operatively coupled to said at least one tension member, and configured for adjusting the length of the at least one tension member in a controlled fashion, and operative in a first mode for receiving energy from a kinetic energy conversion device and for converting it to stored potential energy, and operative in a second mode for releasing the stored potential energy and generating power; and
a kinetic energy conversion device, coupled to said system and configured for converting energy generated by said system to stored potential energy, wherein the storage system and kinetic energy conversion device are deployed on a single platform in the body of water at a location where significant water depth allows the storage and release of energy generated by the kinetic energy conversion device, and wherein the system for storing and releasing energy is configured to store various time frames of energy to meet the needs of one or more of the following; managing peak power demand, load balancing, or voltage management, said stored energy being used on timescales selected from the group consisting of seconds, minutes and hours.

20. The system of claim 19, wherein the kinetic energy conversion device includes at least one wind turbine.

21. The system of claim 19, wherein the kinetic energy conversion device includes at least one tidal or ocean current turbine.

22. The system of claim 19, wherein the kinetic energy conversion device includes at least one wave energy converter.

23. The system of claim 19, wherein the system for storing and releasing energy is used to store various time frames of energy generated by wave energy converters.

24. The system of claim 19, wherein the kinetic energy conversion device comprises two or more types of kinetic energy conversion devices such as one or more wind turbines and one or more wave energy converters.

25. A method for storing and releasing energy, said method comprising the acts of:
providing a platform configured for being deployed generally below the surface of a body of water, said platform configured for storing and releasing energy and comprising:
a buoyancy component, said buoyancy component configured for being generally fully submerged below the surface of a body of water;
one or more suspended weights, coupled to said generally fully submerged buoyancy component;
at least one tension member, coupled to said one or more suspended weights and to said generally fully submerged buoyancy component, each said at least one tension member having a length, and configured for supporting the one or more suspended weights from said generally fully submerged buoyancy component; and
a winch system, operatively coupled to said at least one tension member, and configured for adjusting the length of the at least one tension member in a controlled fashion, and operative in a first mode for receiving energy from an external source and for converting it to stored potential energy, and operative in a second mode for releasing the stored potential energy and generating power;
launching said platform on a body of water and begin moving said platform to a planned deployment location;
after said platform is launched on a body of water and enroute to the planned deployment location, filling one or more low-cost containers that comprise the suspended weight with sand, gravel, or other granular material, and wherein said platform for storing and releasing energy is configured and adapted to store various time frames of energy to meet the needs of one or more of the following; managing peak power demand, load balancing, or voltage management, this stored energy being used on timescales of seconds to hours.

26. The method of claim 25, wherein the sand, gravel, or other granular material is lowered to the low-cost containers from a surface vessel or barge.

27. The method of claim 25, wherein the sand, gravel, or other granular material is raised to the low-cost containers directly from the floor of the body of water in which the system is deployed using one of a dredging or an airlift technique.

28. The method of claim 25, wherein the subsurface buoyancy components and the suspended weight components are fabricated from materials selected from the group of materials consisting of fibers, fabrics, and resins that allow their manufacture at or close to the launch site, eliminating the logistical complexities and costs associated with the transport of large objects.
